(19) United States
(12) Patent Application Publication
(10) Pub. No.: US 2008/0175222 A1
(43) Pub. Date: Jul. 24, 2008

(54) URL PATTERNS FOR MULTI TENANT SYSTEMS

(75) Inventors: Maya Barnea, Kiriat Bialik (IL); Nili Ifergan Guy, Haifa (IL); Gennady Laventman, Haifa (IL); Gal Shachor, Yokneam IIit (IL); Randy A. Rendahl, Raleigh, NC (US); Alexey Roytman, Yoqne'am (IL)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/626,187

(22) Filed: Jan. 23, 2007

(51) Int. Cl. H04L 12/28

(52) U.S. Cl. 370/351

(57) ABSTRACT

A system and method of propagating subscriber and offer identities in URL patterns for multi-tenant systems are provided. The method in one aspect comprises intercepting a request for accessing a web service, the request being in a virtual URI format that includes at least a service access point, subscriber identity and offer identity. The method may further include resolving the virtual URI to determine customer identity, offer identity and destination information, invoking a web service defined in the destination information and returning results of the invoking step. A system, in one aspect, may comprise a router operable to receive a virtual URI, and a route rules database operable to store rules associated with resolving the virtual URI, the router further operable to invoke a service associated with a service access point specified in the virtual URI and return results of the invocation to a requestor.

### FIELD OF THE INVENTION

The present disclosure generally relates to computer systems and more specifically to propagating subscriber and offer identities across calls in hosted offers and/or solutions of multi-tenant systems.

### BACKGROUND OF THE INVENTION

Supplying and hosting software offers for subscribing organizations is a current trend in the hosted software solutions market. An example of this trend is when software provider “A” creates a business and/or solution asset. That asset is then wrapped and published to an offering repository and hosted there, optionally by another company, “B”. Potential customers, for example, who can subscribe to the assets and/or offers can then search the offering repository. The offers may represent a diverse set of capabilities such as human resources, content management services, sales and distribution management solutions, etc. Hosted offers and/or solutions are multi-tenant systems that can be accessed simultaneously by different subscribers. Furthermore, the same offer can be published in different configurations, for example, for platinum, gold and silver clients. In such systems, client requests should be routed to the right services comprising the offer. Because this process takes place during each request, it is desirable to have optimum performance.

Several methods exist for subscriber-based routing. Examples of such subscriber-based routing include authentication-based routing, routing based on originating IP addresses, etc. These approaches have various disadvantages, for example, in that user's identity must be propagated across calls even within the offer, loss of the originating address, code must be added to maintain the subscriber and offer identity across calls. Accordingly, an improved routing method for propagating subscriber and offer identities across calls, for example, without programmer intervention is desirable

### SUMMARY OF THE INVENTION

A system and method of propagating subscriber and offer identities in URL (Uniform Resource Locator) patterns for multi-tenant systems are provided. The method in one aspect comprises intercepting a request for accessing a web service, the request being in a virtual URI (Uniform Resource Identifier) format or similar address format or the like that includes at least a service access point, subscriber identity and offer identity. The method may also include resolving the virtual URI to determine customer identity, offer identity and destination information, invoking a web service defined in the destination information and returning results of the invoking step.

A system for propagating subscriber and offer identities in URL patterns for multi-tenant systems in one aspect may comprise a router operable to receive a virtual URI, the virtual URI including at least a service access point, subscriber identity and offer identity, and a route rules database operable to store rules associated with resolving the virtual URI, the router further operable to invoke a service associated with the service access point and return results of the invocation to a requestor.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates an example of a URI in one embodiment.

FIG. 2 illustrates a routing system, its interfaces with external entities, and the client routing data flow in one embodiment of the present disclosure.

### DETAILED DESCRIPTION OF THE PREFERRED EMBODIMENTS

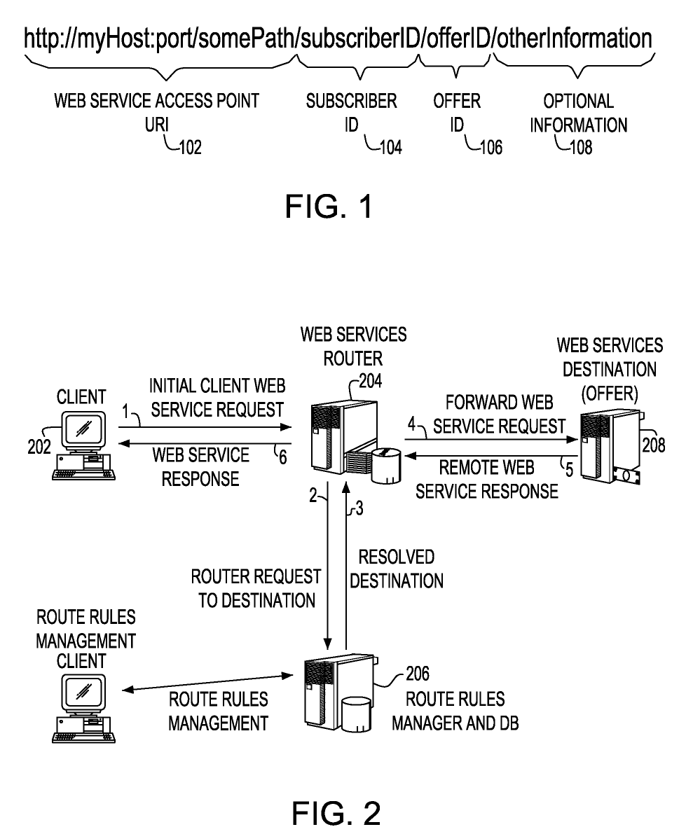

An exemplary embodiment of the present disclosure uses virtual URIs to the requested resources, where the subscriber identity and required offer ID is made part of the URI. The routing system uses a regular expression pattern-based database to resolve subscriber and offer IDs and to map the client requests to the real destination. In an exemplary embodiment, the virtual URIs are injected into the hosted applications during their deployment process. For instance, an automated deployment tool may create and inject the virtual URIs into the hosted application assets that make up the offer. The offers are published over a Web Service interface, for example, as part of the deployment process. Web Service interface is described by a Web Service Definition Language file. This Web Service is accessible by a dynamic URI, where only the initial part of the URI is used to map to the Web Service. In an exemplary embodiment, the rest of the URI contains subscriber, offer and optional additional information. FIG. 1 illustrates an example of a URI in one embodiment. The URI in one embodiment includes an address 102 used to map to the Web Service, subscriber identification (ID) 104, offer ID 106, and other optional information 108.

In an exemplary embodiment, the routing system of the present disclosure may include a Web Services router and its manager with a routing rules database. The Web Services router and its manager with a routing rules database may be installed on the same server or on different servers. For instance, for scalability, reliability and load-balancing considerations, the routing system may be implemented such that the components are split across different servers.

In an exemplary embodiment, the routing system further may have two external Web Service interfaces: management and routing. In one embodiment, the management interface is used, for example, for creating, updating, querying, and removing the routing rules. The routing interface in one embodiment is used, for example, by various clients of the system to access remote Web Services. In one embodiment, the router may use an internal cache to reduce the communication between the router and the manager, and consequently reduce the client request latency.

FIG. 2 illustrates a routing system, its interfaces with external entities, and the client routing data flow in one embodiment of the present disclosure. The following description illustrates a system data flow in an exemplary embodiment of the present disclosure. A remote client 202 sends a Web Service request to the router as indicated by the arrow denoted 1. In an exemplary embodiment, the request contains the URI format shown in FIG. 1. The router 204 calculates the destination by interpreting the received URI request using one or more rules. For example, it first checks a local cache for the request destination. If the request destination is not found, it calls a rules manager 206 to discover the destination as indicated by the arrow denoted 2. The rules manager 206 checks its route rules database and returns the request destination or an error if a destination cannot be found as indicated by the arrow denoted 3. In one embodiment, the processes denoted by arrows 2 and 3 may be executed sequentially and/or iteratively for resolving the subscriber ID, offer ID, and finally the destination. The router 204 forwards the original client request to the destination 208 as shown by the arrow denoted 4. If there was an error in resolving the destination, the router 204 may return an error condition. As illustrated by arrow denoted 5, the remote server 208 returns the result of the Web Service invocation. The router 204 sends the results back to the client 202 as shown by the arrow denoted 6.

In one aspect, the subscriber and offering information can be used for billing. For instance, as the virtual URI passes through various components of the router, the information contained therein may be captured or logged by the various components and used appropriately. The explicit listing in the URI allows more specific logging of calls that are easily mapped to offers and subscribers.

In one embodiment, the routing rules can be managed through separate interfaces. For example, in addition to providing the routing services, other interfaces may exist or may be defined to allow creation and removal of the routing rules. Further, while FIG. 1 is shown without authentication information, the offer resolving mechanism of the present disclosure may also include such information.

In one embodiment, the routing mechanism of the present disclosure can use very simple and effective regular expression rules for subscriber, offer and service destination resolutions. For example, the system has the following routing rules:
Subscriber rule: http://.*/mycustomer/.*->firstSubscriber
   The above rule means that all HTTP requests with URI that contains ‘myCustomer’ string belong to firstSubscriber. The rule,
Offer rule: http://.*/myCustomer/mySolution/.*->firstOffer
   Translates all HTTP requests from firstSubscriber AND with URI that contains ‘mySolution’ string to firstOffer.

An example of a destination rule may include:
http://.*/myCustomer/mySolution/TheGoldLevelStockService->
http://ExternalHost:80/WebServicePath/StockQuote
   The above destination rule indicates that all HTTP requests from firstSubscriber to firstOffer and that require ‘TheGoldLevelStockService’ will be forwarded to an external service with URI
http://ExternalHost:80/WebServicePath/StockQuote

Therefore, the ingoing URI into the deployed solution may have the following address:
http://WebServiceRouterHost:80/Solutionplatform/myCustomer/mySolution/TheGoldLevelStockService

According to the above routing rules and using pattern mapping, the router discovers the subscriber (customer) and offer (solution) names, and matches them to the appropriate stock service, based on the customer, solution, and/or service level (gold) defined in the pattern.

The request is forwarded to the actual endpoint:
http://ExternalHost:80/WebServicePath/StockQuote

In one embodiment, the endpoint service may have access to logged information containing the offer and subscriber information, which may be used by the endpoint to bill firstSubscriber according to firstOffer.

The system and method of the present disclosure may be implemented on general purpose computer, specific purpose computer or the like. The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of propagating subscriber and offer identities in URL patterns for multi-tenant systems, comprising:
intercepting a request for accessing a web service, the request being in a virtual URI format that includes at least a service access point, subscriber identity and offer identity;
resolving the virtual URI to determine customer identity, offer identity and destination information;
invoking a web service defined in the destination information; and
returning results of the invoking step.

2. The method of claim 1, wherein the step of resolving includes at least:
checking one or more rules stored in a route rules database having at least a plurality of subscriber rules and destination rules; and
determining the customer identity and offer identity using the subscriber rules; and
determining the destination information using the destination rules.

3. The method of claim 1, wherein the virtual URI includes additional information about a subscriber associated with the customer identity.

4. A system for propagating subscriber and offer identities in URL patterns for multi-tenant systems, comprising:
a router operable to receive a virtual URI, the virtual URI including at least a service access point, subscriber identity and offer identity; and
a route rules database operable to store rules associated with resolving the virtual URI, the router further operable to invoke a service associated with the service access point and return results of the invocation to a requestor.

5. The system of claim 4, further including:
one or more interfaces operable to create and update the one or more rules for resolving the virtual URI.
